(19) United States
(12) Patent Application Publication
(10) Pub. No.: US 2013/0163548 A1
(43) Pub. Date: Jun. 27, 2013

(54) TERMINAL APPARATUS FOR BROADCASTING SIGNAL CONTAINING PREDETERMINED INFORMATION

(71) Applicant: PANASONIC CORPORATION, Osaka (JP)

(72) Inventors: Makoto NAGAI, Kakamigahara-shi (JP); Fuminori TAKAMA, Tottori-shi (JP)

(73) Assignee: PANASONIC CORPORATION, Osaka (JP)

(21) Appl. No.: 13/772,198

(22) Filed: Feb. 20, 2013

Related U.S. Application Data
(63) Continuation of application No. PCT/JP2011/007133, filed on Dec. 20, 2011.

(30) Foreign Application Priority Data
Mar. 25, 2011 (JP) 2011-067986

(51) Int. Cl. H04W 72/12

(52) U.S. Cl. CPC H04W 72/1205
USPC 370/329

(57) ABSTRACT

A RF unit and a modem unit receive a packet signal from a base station apparatus, the packet signal containing information on a frame structure in a first period in a frame containing at least the first period and a second period. An extraction unit specifies the second period in the frame based on the received packet signal. A setting unit sets a wait time in the specified second period. A carrier sense unit performs carrier sensing for the set wait time. The modem unit and the RF unit broadcast a packet signal based on a carrier sensing result.

### BACKGROUND OF THE INVENTION

1. Field of the Invention

The present invention relates to a communication technique, and particularly to a terminal apparatus for broadcasting a signal containing predetermined information.

2. Description of the Related Art

A road-to-vehicle communication is being discussed in order to prevent head-on collision accidents at the intersections. Information on a situation of an intersection is communicated between a roadside apparatus and a vehicle-mounted apparatus in the road-to-vehicle communication. Roadside apparatuses need to be installed for the road-to-vehicle communication, and thus time and cost therefor increase.

To the contrary, roadside apparatuses do not need to be installed in inter-vehicular communication, or in a form in which information is communicated between vehicle-mounted apparatuses. In this case, current position information is detected by GPS (Global Positioning System) or the like in real-time and the position information is exchanged between the vehicle-mounted apparatuses so that a determination is made as to on which road the vehicle and other vehicle are positioned to enter the intersection.

A terminal apparatus is mounted on a vehicle and is additionally carried with a pedestrian. Even when the terminal apparatus carried with a pedestrian transmits a packet signal in broadcast, a small impact is desirably given to a packet signal transmitted in broadcast from the vehicle-mounted terminal apparatus. It is desirable that the terminal apparatus carried with a pedestrian can preferentially broadcast a packet signal prior to the vehicle-mounted terminal apparatus in order to notify a presence position of the pedestrian.

### SUMMARY OF THE INVENTION

The present invention has been made in terms of the above situations, and an object thereof is to provide a technique for preferentially broadcasting a packet signal while reducing impacts given to a packet signal broadcasted from other terminal apparatus even when a packet signal is broadcasted from a terminal apparatus needing low power consumption.

In order to solve the above problem, a terminal apparatus according to an aspect of the present invention includes a receiving unit for receiving a packet signal from a base station apparatus, the packet signal containing information on a frame structure in a first period in a frame containing at least the first period and a second period, a specification unit for specifying the second period in the frame based on the packet signal received in the receiving unit, a setting unit for setting await time in the second period specified in the specification unit, a carrier sense unit for performing carrier sensing for the wait time set in the setting unit, and a broadcasting unit for broadcasting a packet signal based on a result of the carrier sensing in the carrier sense unit. A range of the wait time settable in the setting unit is narrower than a range of the wait time settable for carrier sensing by other terminal apparatus capable of broadcasting a packet signal in the second period.

Any combination of the constituents, and a modified representation of the present invention in a method, a apparatus, a system, a recording medium and a computer program are also effective as an aspect of the present invention.

### BRIEF DESCRIPTION OF THE DRAWINGS

FIG. 1 is a diagram illustrating a structure of a communication system according to an embodiment of the present invention;

FIG. 2 is a diagram illustrating a structure of a base station apparatus of FIG. 1;

FIGS. 3A to 3D are diagrams illustrating a format of a frame defined in the communication system of FIG. 1;

FIGS. 4A to 4B are diagrams illustrating the subframes of FIGS. 3A to 3D;

FIGS. 5A to 5B are diagrams illustrating a format of a MAC frame stored in a packet signal defined in the communication system of FIG. 1;

FIG. 6 is a diagram illustrating a structure of a vehicle-mounted terminal apparatus mounted on a vehicle of FIG. 1;

FIG. 7 is a diagram illustrating a structure of a portable terminal apparatus carried with a pedestrian of FIG. 1;

FIG. 8 is a diagram illustrating an operation of the portable terminal apparatus of FIG. 7;

FIG. 9 is a diagram illustrating a format of a frame according to a modification of an exemplary embodiment; and

FIG. 10 is a diagram illustrating a format of a frame according to another modification of an exemplary embodiment.

### DETAILED DESCRIPTION OF THE INVENTION

The invention will now be described by reference to the preferred embodiments. This does not intend to limit the scope of the present invention, but to exemplify the invention.

Before specifically describing an embodiment, a basic concept is described. Wireless LAN (Local Area Network) conforming to the standard of IEEE802.11 or the like employs an access control function called CSMA/CA (Carrier Sense Multiple Access with Collision Avoidance). Thus, the same wireless channel is shared between a plurality of terminal apparatuses in the wireless LAN. In the CSMA/CA, it is confirmed that other packet signal is not transmitted by carrier sensing, and then a packet signal is transmitted. When the wireless LAN is applied to inter-vehicular communication such as ITS (Intelligent Transport Systems), information needs to be transmitted to the terminal apparatuses mounted on many vehicles, and thus a signal is desirably transmitted in broadcast. Consequently, the terminal apparatus receives the broadcasted signal thereby to detect an approach of other vehicle, and notifies it to the driver thereby to alert the drive for preventing collision accidents between the vehicles.

It is desired to prevent collision accidents between vehicles and to prevent collisions between pedestrians and vehicles. To address this, the terminal apparatus is mounted on a vehicle and is additionally carried with a pedestrian. In order to prevent a pedestrian from being crashed by a vehicle, the terminal apparatus carried with a pedestrian notifies a presence position to a vehicle-mounted terminal apparatus. On the other hand, the terminal apparatus carried with a pedestrian is battery-driven, and thus the processing amount needs to be further reduced than the vehicle-mounted terminal apparatus. For example, an approach of other vehicle is not notified to the pedestrian. Even when the terminal apparatus carried with a pedestrian transmits a packet signal in broadcast, a small impact is desirably given to a packet signal transmitted in broadcast from the vehicle-mounted terminal apparatus. It is desirable that the terminal apparatus carried with a pedestrian can preferentially broadcast a packet signal prior to the vehicle-mounted terminal apparatus in order to notify a presence position of the pedestrian.

The embodiment of the present invention relates to a communication system for making inter-vehicular communication between terminal apparatuses mounted on vehicles (which will be referred to as “vehicle-mounted terminal apparatus” below) and for making road-to-vehicle communication from a base station apparatus installed at an intersection or the like to a vehicle-mounted terminal apparatus. For the inter-vehicular communication, the vehicle-mounted terminal apparatus transmits a packet signal storing information on vehicle speed or position (which will be referred to as “data” below) therein in broadcast. Other vehicle-mounted terminal apparatus receives the packet signal and recognizes an approach of a vehicle based on the data. The approach of a vehicle is notified to the driver thereby to alert the driver. The base station apparatus repeatedly defines a frame containing a plurality of subframes in order to reduce interferences between the inter-vehicular communication and the road-to-vehicle communication. The base station apparatus selects any of the subframes for the road-to-vehicle communication, and transmits a packet signal storing control information or the like therein in broadcast in a period of the header of the selected subframe. The control information contains information on a period in which the base station apparatus transmits a packet signal in broadcast (which will be referred to as “road-to-vehicle transmission period” below).

The vehicle-mounted terminal apparatus specifies the road-to-vehicle transmission period based on the control information, and transmits a packet signal in a period other than the road-to-vehicle transmission period. In this way, the road-to-vehicle communication and the inter-vehicular communication are time-multiplexed so that a probability of collision of the packet signals therebetween can be reduced. The inter-vehicular communication is made in the CSMA system in a period in which the inter-vehicular communication is made (which will be referred to as “inter-vehicular transmission period” below) other than the road-to-vehicle transmission period. The terminal apparatus is carried with a pedestrian (a terminal apparatus carried with a pedestrian will be referred to as “portable terminal apparatus” below). The portable terminal apparatus is battery-driven, and thus needs lower power consumption. Thus, the portable terminal apparatus only transmits a packet signal storing data therein in broadcast, and does not notify an approach of a vehicle to the pedestrian.

Even when the portable terminal apparatus transmits a packet signal in broadcast, an impact on a packet signal transmitted from the vehicle-mounted terminal apparatus in broadcast needs to be reduced. An object of the portable terminal apparatus to transmit a packet signal in broadcast is to notify a presence position of the pedestrian to drivers. Thus, it is desired that the portable terminal apparatus can preferentially transmit prior to the vehicle-mounted terminal apparatus. In order to address the same, the communication system according to the present embodiment performs the following processing. In the following, the inter-vehicular communication and the road-to-vehicle communication are used for the portable terminal apparatus. The vehicle-mounted terminal apparatus and the portable terminal apparatus are not discriminated from each other and may be both referred to as “terminal apparatus”, and the vehicle-mounted terminal apparatus and the portable terminal apparatus maybe collectively referred to as “terminal apparatus”.

The portable terminal apparatus also performs the CSMA system in the inter-vehicular transmission period similarly to the vehicle-mounted terminal apparatus. Herein, since the portable terminal apparatus needs lower power consumption than the vehicle-mounted terminal apparatus, the amount of information transmitted from the portable terminal apparatus in broadcast is less than the amount of information transmitted from the vehicle-mounted terminal apparatus in broadcast. Consequently, a length of the packet signal of the former is shorter than a length of the packet signal of the latter. In the CSMA system, a length of a contention window is variable, and carrier sensing is performed in the period. If the packet signal has a short length but has the same maximum value of the contention window, a wait time for the length of the packet signal is longer. To address this, the maximum value of the contention window in the portable terminal apparatus is defined to be smaller than the maximum value of the contention window in the vehicle-mounted terminal apparatus.

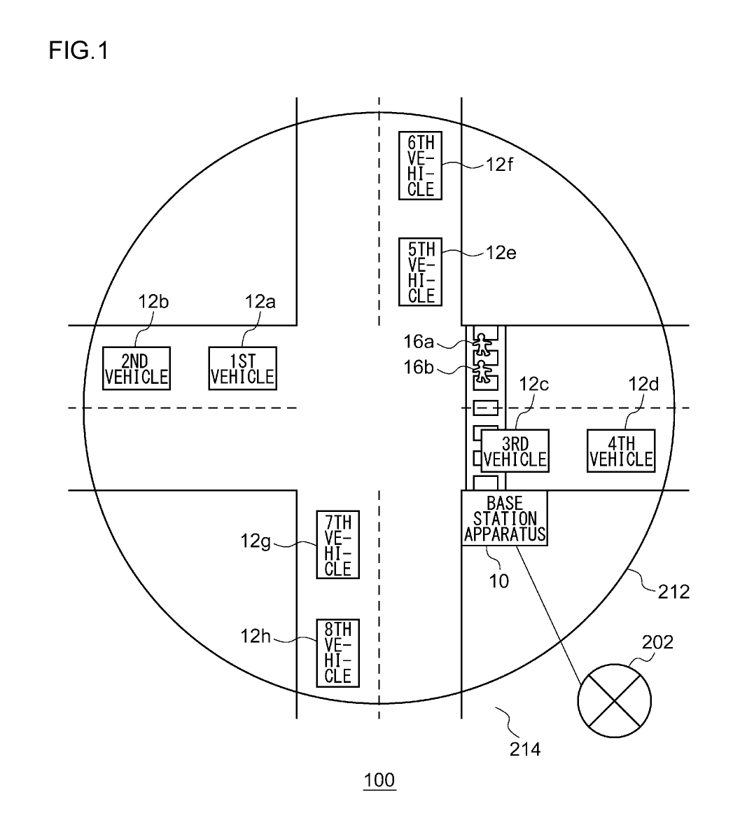

FIG. 1 illustrates a structure of a communication system 100 according to the embodiment of the present invention. This corresponds to a case in which an intersection is viewed from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, an eighth vehicle 12h which are collectively referred to as vehicle 12, and a first pedestrian 16a and a second pedestrian 16b which are collectively referred to as pedestrian 16. Each vehicle 12 is installed with a vehicle-mounted terminal apparatus (not shown), and each pedestrian 16 carries a portable terminal apparatus (not shown). An area 212 is formed around the base station apparatus 10, and an outer area 214 is formed outside the area 212.

As illustrated, a road in the horizontal direction of the figure or in the right and left direction and a road in the vertical direction of the figure or in the up and down direction intersect at the center. Herein, the upper side of the figure corresponds to “north”, the left side corresponds to “west”, the lower side corresponds to “south”, and the right side corresponds to “east”. The crossover part of the two roads is an “intersection.” The first vehicle 12a and the second vehicle 12b travel from left to right, and the third vehicle 12c and the fourth vehicle 12d travel from right to left. The fifth vehicle 12e and the sixth vehicle 12f travel from top to bottom, and the seventh vehicle 12g and the eighth vehicle 12h travel from bottom to top.

The base station apparatus 10 controls communication between the terminal apparatuses. The base station apparatus 10 repeatedly generates a frame containing a plurality of subframes based on a signal received from a GPS satellite (not shown) or a frame formed in other base station apparatus 10 (not shown). Herein, there is defined that the road-to-vehicle transmission period can be set at the header of each subframe. The base station apparatus 10 selects a subframe for which the road-to-vehicle transmission period is not set by other base station apparatus 10 among the subframes. The base station apparatus 10 sets the road-to-vehicle transmission period at the header of the selected subframe. The base station apparatus 10 broadcasts a packet signal in the set road-to-vehicle transmission period.

The vehicle 12 is engine-driven and mounts a vehicle-mounted terminal apparatus thereon. The vehicle-mounted terminal apparatus generates a frame based on the control information contained in the received packet signal. Consequently, the frames generated in the respective vehicle-mounted terminal apparatuses are synchronized with a frame generated in the base station apparatus 10. The vehicle-mounted terminal apparatus performs CSMA/CA in the inter-vehicular transmission period thereby to broadcast a packet signal. The vehicle-mounted terminal apparatus stores information on a presence position in the packet signal. The vehicle-mounted terminal apparatus stores the control information in the packet signal. That is, the control information transmitted from the base station apparatus 10 is transferred by the vehicle-mounted terminal apparatus.

On the other hand, the a vehicle-mounted terminal apparatus which cannot receive a packet signal from the base station apparatus 10, or a vehicle-mounted terminal apparatus present in the outer area 214 performs CSMA/CA irrespective of the frame structure, thereby broadcasting a packet signal. Further, the vehicle-mounted terminal apparatus receives a packet signal from other vehicle-mounted terminal apparatus, thereby broadcasting an approach of other vehicle mounting a vehicle-mounted terminal apparatus thereon to the driver.

The pedestrian 16 carries a portable terminal apparatus. The portable terminal apparatus performs the same processings as the vehicle-mounted terminal apparatus. However, the portable terminal apparatus does not notify an approach of a vehicle or the like for simplifying the processings. The portable terminal apparatus sets a contention window such that an average wait time on the CSMA/CA is shorter than an average wait time of the vehicle-mounted terminal apparatus. Further, transmission power of the portable terminal apparatus is set to be smaller than transmission power of other apparatus.

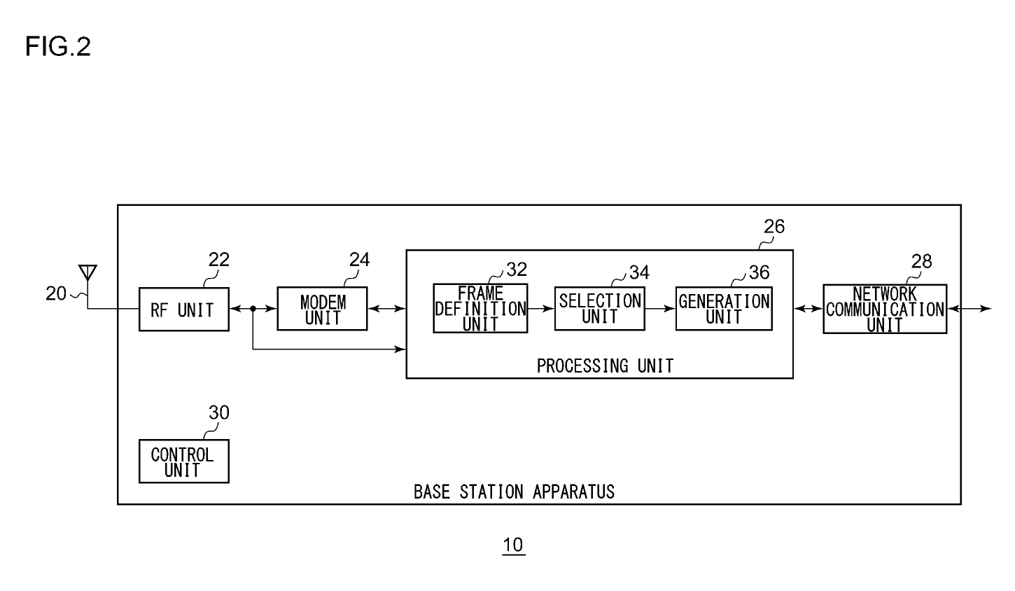

FIG. 2 illustrates a structure of the base station apparatus 10. The base station apparatus 10 includes an antenna 20, a RF unit 22, a modem unit 24, a processing unit 26, a network communication unit 28 and a control unit 30. The processing unit 26 includes a frame definition unit 32, a selection unit 34 and a generation unit 36.

The RF unit 22 receives a packet signal from a terminal apparatus or other base station apparatus 10 (not shown) by the antenna 20 for the reception processing. The RF unit 22 performs frequency conversion on the received wireless frequency packet signal, and generates a baseband packet signal. The RF unit 22 further outputs the baseband packet signal to the modem unit 24. Typically, the baseband packet signal is formed of an in-phase component and a quadrature component and thus should be indicated by two signal lines, but only one signal line is indicated herein for clarifying the figure. The RF unit 22 includes a LNA (Low Noise Amplifier), a mixer, an AGC and an A/D conversion unit.

The RF unit 22 performs frequency conversion on the baseband packet signal input from the modem unit 24 and generates a wireless frequency packet signal as the transmission processing. The RF unit 22 further transmits the wireless frequency packet signal from the antenna 20 in the road-to-vehicle transmission period. The RF unit 22 includes a PA (Power amplifier), a mixer, and a D/A conversion unit.

The modem unit 24 demodulates the baseband packet signal from the RF unit 22 as the reception processing. The modem unit 24 further outputs a demodulation result to the processing unit 26. The modem unit 24 modulates the data from the processing unit 26 as the transmission processing. The modem unit 24 further outputs a modulation result as a baseband packet signal to the RF unit 22. Herein, the communication system 100 copes with the OFDM (Orthogonal Frequency Division Multiplexing) modulation system, and thus the modem unit 24 also performs FFT (Fast Fourier Transform) as the reception processing and performs IFFT (Inverse Fast Fourier Transform) as the transmission processing.

The frame definition unit 32 receives a signal from a GPS satellite (not shown) and acquires time information based on the received signal. A well-known technique may be used for acquiring the time information, and an explanation thereof will be omitted. The frame definition unit 32 generates a plurality of frames based on the time information. For example, the frame definition unit 32 divides a period of “1 sec” into 10 with reference to the timings indicated in the time information, thereby to generate 10 frames of “100 msec”. The processings are repeated so that the frames are defined to be repeated.

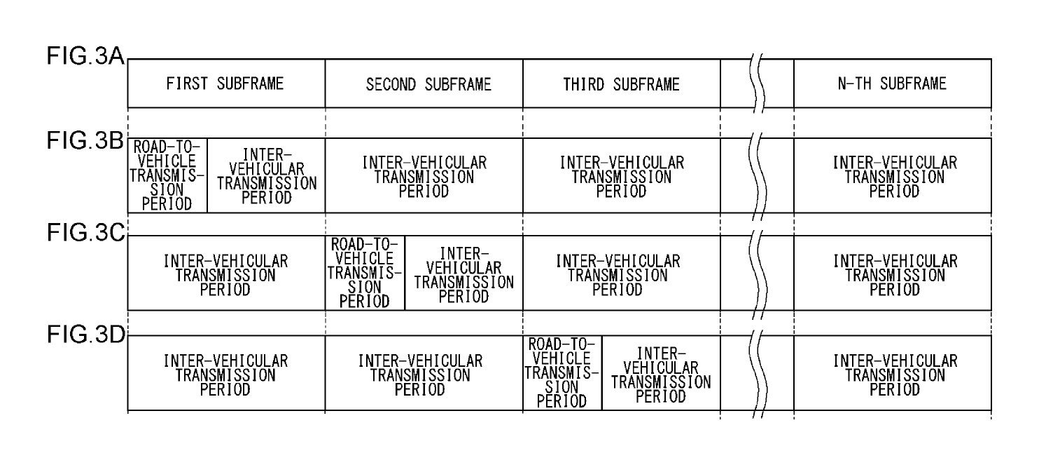

The frame definition unit 32 may detect the control information from the demodulation result and generate a frame based on the detected control information. The processing corresponds to generating a frame synchronized with a timing of a frame formed by other base station apparatus 10. FIGS. 3A to 3D illustrate formats of frames defined in the communication system 100. FIG. 3A illustrates a structure of a frame. The frame is formed of N subframes indicated as the first subframe to the N-th subframe. For example, when a length of the frame is 100 msec and N is 8, a subframe with a length of 12.5 msec is defined. The description of FIGS. 3A to 3B will be made later and return to FIG. 2.

The selection unit 34 selects a subframe for which the road-to-vehicle transmission period is to be set from among the subframes contained in the frame. More specifically, the selection unit 34 receives the frame defined in the frame definition unit 32. The selection unit 34 inputs the demodulation results from other base station apparatus 10 or terminal apparatus (not shown) via the RF unit 22 and the modem unit 24. The selection unit 34 extracts the demodulation result from other base station apparatus 10 from among the input demodulation results. The selection unit 34 specifies a subframe receiving the demodulation result thereby to specify the subframes not receiving the demodulation result. This corresponds to specifying the subframes for which the road-to-vehicle transmission period is not set by other base station apparatus 10 or unused subframes. When a plurality of unused subframes is present, the selection unit 34 randomly selects one subframe. When an unused subframe is not present or when a plurality of subframes is used, the selection unit 34 acquires reception power corresponding to the demodulation result and preferentially selects a subframe with low reception power.

FIG. 3B illustrates a structure of a frame generated by a first base station apparatus 10a. The first base station apparatus 10a sets the road-to-vehicle transmission period at the header of the first subframe. The first base station apparatus 10a sets the inter-vehicular transmission period subsequent to the road-to-vehicle transmission period in the first subframe. The inter-vehicular transmission period is a period in which the vehicle-mounted terminal apparatus can broadcast a packet signal. That is, there is defined such that the first base station apparatus 10a can broadcast a packet signal in the road-to-vehicle transmission period at the header period of the first subframe and the vehicle-mounted terminal apparatus can broadcast a packet signal in the inter-vehicular transmission period other than the road-to-vehicle transmission period in the frame. Further, the first base station apparatus 10a sets only the inter-vehicular transmission period in the second subframe to the N-th subframe.

FIG. 3C illustrates a structure of a frame generated by a second base station apparatus 10b. The second base station apparatus 10b sets the road-to-vehicle transmission period at the header of the second subframe. The second base station apparatus 10b sets the inter-vehicular transmission period subsequent to the road-to-vehicle transmission period in the second subframe, and in the first subframe, and the third subframe to the N-th subframe. FIG. 3D illustrates a structure of a frame generated by a third base station apparatus 10c. The third base station apparatus 10c sets the road-to-vehicle transmission period at the header of the third subframe. The third base station apparatus 10c sets the inter-vehicular transmission period subsequent to the road-to-vehicle transmission period in the third subframe, and in the first subframe, the second subframe, and the fourth subframe to the N-th subframe. In this way, the base station apparatuses 10 select mutually-different subframes, and set the road-to-vehicle transmission period at the headers of the selected subframes, respectively. Return to FIG. 2. The selection unit 34 outputs a number of the selected subframe to the generation unit 36.

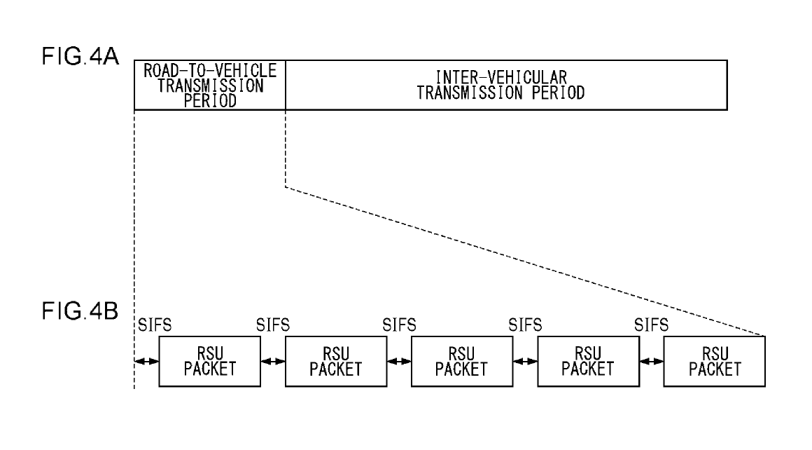

The generation unit 36 sets the road-to-vehicle transmission period in the subframe with the subframe number received from the selection unit 34, and generates a RSU packet signal to be broadcasted in the road-to-vehicle transmission period. In the following explanation, the RSU packet signal and the packet signal are not discriminated from each other for use. FIGS. 4A to 4B illustrate the structures of the subframes. FIG. 4A illustrates a subframe for which the road-to-vehicle transmission period is set. As illustrated, one subframe is configured of the road-to-vehicle transmission period and the inter-vehicular transmission period in this order. FIG. 4B illustrates an arrangement of the packet signals in the road-to-vehicle transmission period. As illustrated, a plurality of RSU packet signals is arranged in the road-to-vehicle transmission period. The previous or next packet signals are separated from each other by SIFS (Short Interframe Space).

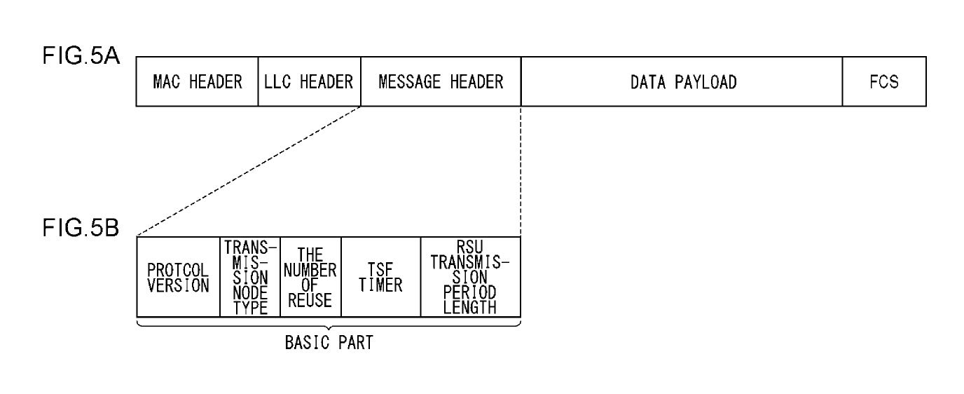

A structure of the RSU packet signal will be described herein. FIGS. 5A and 5B illustrate a format of a MAC frame stored in a packet signal defined in the communication system 100. FIG. 5A illustrates a format of a MAC frame. The MAC frame arranges therein “MAC header”, “LLC header”, “message header”, “data payload” and “FCS” from the head in this order. Information contained in the data payload will be described later. FIG. 5B is a diagram illustrating a structure of a message header generated by the generation unit 36. The message header contains a basic part.

The basic part contains “protocol version”, “transmission node type”, “the number of reuse”, “TSF timer” and “RSU transmission period length”. Protocol version indicates a version of a corresponding protocol. Transmission node type indicates a transmission source of a packet signal containing a MAC frame. For example, “0” indicates a terminal apparatus and “1” indicates a base station apparatus 10. When the vehicle-mounted terminal apparatus and the portable terminal apparatus are discriminated from each other, the transmission node type is indicated in two bits. When the selection unit 34 extracts the demodulation result from other base station apparatus 10 from among the demodulation results, the selection unit 34 uses a value of the transmission node type. The number of reuse indicates an effective index when the message header is transferred by the terminal apparatus, and TSF timer indicates a transmission time. RSU transmission period length indicates a length of the road-to-vehicle transmission period, and may be information on the road-to-vehicle transmission period. Return to FIG. 2.

The network communication unit 28 is connected to a network 202 (not shown). The network communication unit 28 receives traffic jam information from the network 202. The generation unit 36 acquires the traffic jam information from the network communication unit 28 and stores it in the data payload, thereby generating the RSU packet signal. The control unit 30 controls the entire processings of the base station apparatus 10.

The structure can be realized by a CPU, a memory or other LSI in any computer in hardware, and can be realized by a program loaded in a memory in software, but the functional blocks realized in their association are depicted herein. Thus, those skilled in the art should understand that the functional blocks can be realized in any form such as hardware only, software only or a combination thereof.

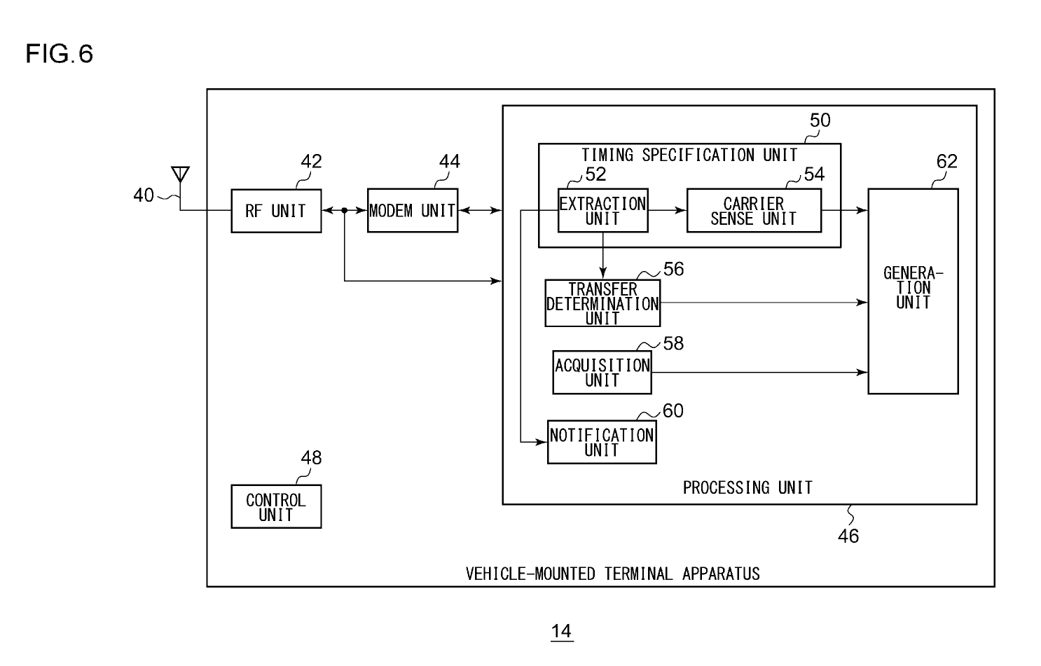

FIG. 6 illustrates a structure of the vehicle-mounted terminal apparatus 14 mounted on the vehicle 12. The vehicle-mounted terminal apparatus 14 includes an antenna 40, a RF unit 42, a modem unit 44, a processing unit 46, and a control unit 48. The processing unit 46 includes a timing specification unit 50, a transfer determination unit 56, an acquisition unit 58, a notification unit 60, and a generation unit 62, and the timing specification unit 50 includes an extraction unit 52 and a carrier sense unit 54. The antenna 40, the RF unit 42 and the modem unit 44 perform the same processings as the antenna 20, the RF unit 22 and the modem unit 24 in FIG. 2. Thus, differences will be mainly described herein.

The modem unit 44 and the processing unit 46 receive a packet signal from other terminal apparatus or base station apparatus 10 (not shown). As described above, the modem unit 44 and the processing unit 46 receive a packet signal from the base station apparatus 10 in the road-to-vehicle transmission period. As described above, the modem unit 44 and the processing unit 46 receive a packet signal from other vehicle-mounted terminal apparatus 14 in the inter-vehicular transmission period. Further, though described later in detail, the modem unit 44 and the processing unit 46 receive a packet signal from a portable terminal apparatus (not shown) irrespective of the road-to-vehicle transmission period or the inter-vehicular transmission period.

When the demodulation result from the modem unit 44 is a packet signal from a base station apparatus 10 (not shown), the extraction unit 52 specifies a timing of a subframe in which the road-to-vehicle transmission period is arranged. At this time, the extraction unit 52 estimates to be present within the area 212 of FIG. 1. The extraction unit 52 generates a frame based on the timing of the subframe, the contents of the message header of the packet signal, specifically, the contents of the RSU transmission period length. The frame may be generated similarly as in the frame definition unit 32, and thus an explanation thereof will be omitted. Consequently, the extraction unit 52 generates a frame synchronized with the frame formed in the base station apparatus 10.

On the other hand, when not receiving a RSU packet signal, the extraction unit 52 estimates to be present in the outer area 214 of FIG. 1. When estimating to be present within the area 212, the extraction unit 52 selects the inter-vehicular transmission period. When estimating to be present in the outer area 214, the extraction unit 52 selects a timing irrespective of the frame structure. When selecting the inter-vehicular transmission period, the extraction unit 52 outputs the information on the timings of the frame and the subframe and the inter-vehicular transmission period to the carrier sense unit 54. When selecting the timing irrespective of the frame structure, the extraction unit 52 instructs the carrier sense unit 54 to perform carrier sensing.

The carrier sense unit 54 receives the information on the timings of the frame and the subframe and the inter-vehicular transmission period from the extraction unit 52. The carrier sense unit 54 performs carrier sensing in the inter-vehicular transmission period, thereby measuring interference power. The carrier sense unit 54 determines a transmission timing in the inter-vehicular transmission period based on the interference power. Specifically, the carrier sense unit 54 previously stores a predetermined threshold, and compares the interference power with the threshold. When the interference power is lower than the threshold, the carrier sense unit 54 determines a transmission timing. When being instructed to perform carrier sensing from the extraction unit 52, the carrier sense unit 54 performs CSMA thereby to determine a transmission timing irrespective of the frame structure. The carrier sense unit 54 notifies the determined transmission timing to the generation unit 62.

The acquisition unit 58 includes a GPS receiver, a gyro sensor, a vehicle speed sensor or the like (not shown), and acquires a presence position, a travelling direction, a moving speed and the like (which will be collectively referred to as “position information” below) of the vehicle-mounted terminal apparatus 14 based on the data supplied therefrom. The presence position is indicated by latitude and longitude. A well-known technique maybe used for the acquisition, and thus an explanation thereof will be omitted. The acquisition unit 58 outputs the position information to the generation unit 62.

The transfer determination unit 56 controls transfer of the message header. The transfer determination unit 5 6 extracts the message header from the packet signal. When the packet signal is directly transmitted from the base station apparatus 10, the number of reuse is set at “0”, but when the packet signal is transmitted from other vehicle-mounted terminal apparatus 14, the number of reuse is set at a value of “1 or more.” The transfer determination unit 56 selects the message header to be transferred from among the extracted message headers. Herein, the message header with the smallest number of reuse is selected herein. The transfer determination unit 56 may generate a new message header by combining the contents contained in the message headers. The transfer determination unit 56 outputs the message header to be selected to the generation unit 62. At this time, the transfer determination unit 56 increments the number of reuse by “1”.

The generation unit 62 receives the position from the acquisition unit 58, and receives the message header from the transfer determination unit 56. The generation unit 62 uses the MAC frame illustrated in FIGS. 5A and 5B to store the position information in the data payload. The generation unit 62 generates a packet signal containing the MAC frame and transmits the generated packet signal in broadcast via the modem unit 55, the RF unit 42 and the antenna 40 at the transmission timing determined in the carrier sense unit 54. This corresponds to the inter-vehicular communication. The transmission timing is contained in the road-to-vehicle transmission period.

The notification unit 60 acquires a packet signal from a base station apparatus 10 (not shown) via the extraction unit 52, and acquires a packet signal from other vehicle-mounted terminal apparatus 14 (not shown). The notification unit 60 notifies an approach of other vehicle 12 or a pedestrian 16 (not shown) to the deriver via a monitor or speaker according to the contents of the data stored in the packet signal as the processing on the acquired packet signal. Further, the notification unit 60 notifies the traffic jam information and the like to the driver via a monitor or speaker.

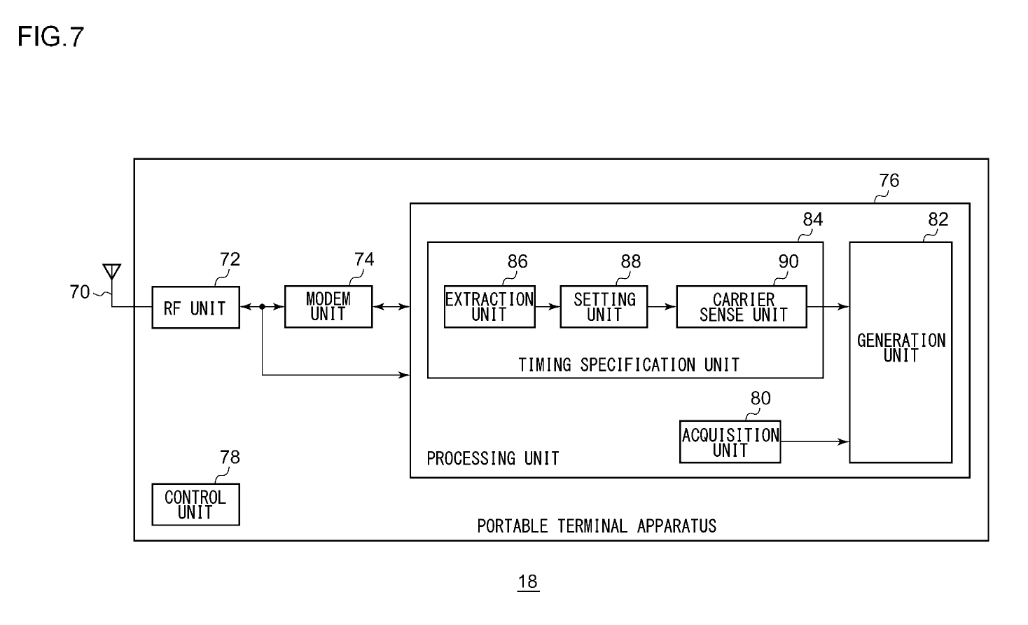

FIG. 7 illustrates a structure of a portable terminal apparatus 18 carried with a pedestrian 16. The portable terminal apparatus 18 includes an antenna 70, a RF unit 72, a modem unit 74, a processing unit 76 and a control unit 78. The processing unit 76 includes an acquisition unit 80, a generation unit 82 and a timing specification unit 84, and the timing specification unit 84 includes an extraction unit 86, a setting unit 88 and a carrier sense unit 90. The acquisition unit 80 acquires position information similarly to the acquisition unit 58 of FIG. 6. The acquisition unit 80 outputs the position information to the generation unit 82.

The modem unit 74 and the processing unit 76 receive a packet signal from other terminal apparatus or base station apparatus 10 (not shown) similarly to the modem unit 44 and the processing unit 46 of FIG. 6. Particularly, the modem unit 74 and the processing unit 76 receive a packet signal from the base station apparatus 10, the packet signal containing the information on the frame structure, in the road-to-vehicle transmission period in the frame containing at least the road-to-vehicle transmission period and the inter-vehicular transmission period. When the demodulation result from the modem unit 74 is a packet signal from the base station apparatus 10 (not shown), the extraction unit 86 specifies a timing of the subframe in which the road-to-vehicle transmission period is arranged similarly to the extraction unit 52. The extraction unit 86 specifies the inter-vehicular transmission period and outputs the information on the timings of the frame and subframe and the inter-vehicular transmission period. On the other hand, when selecting a timing irrespective of the frame structure, the extraction unit 86 designates, to the setting unit 88, that a frame is not defined.

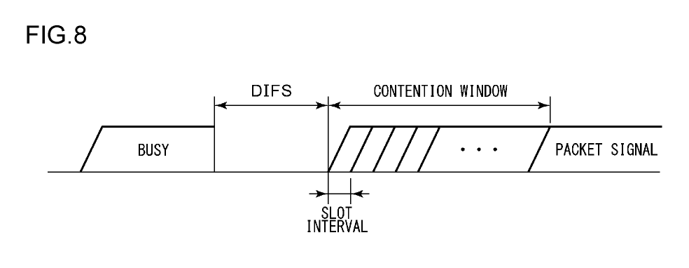

When receiving the information on the timings of the frame and subframe and the inter-vehicular transmission period from the extraction unit 86, the setting unit 88 sets a wait time for carrier sensing in the inter-vehicular transmission period. An outline of the CSMA operation by carrier sensing will be described herein. FIG. 8 illustrates an operation of the portable terminal apparatus 18. The horizontal axis indicates time. Busy indicates a state in which a signal is being received from other apparatus. After the busy state ends, waiting is performed during DIFS (DCF IFS). After the DIFS ends, waiting is also performed during the contention window. If a signal is not received during the period, a packet signal is transmitted. The contention window is configured of a plurality of slots. A size of one slot is 13 μsec. The number of slots is defined by a random number of 0 to N. A length of a packet signal broadcasted from the portable terminal apparatus 18 is shorter than a length of a packet signal broadcasted from the vehicle-mounted terminal apparatus 14.

Thus, if the period of the contention window is the same between both apparatuses, the former is longer than the latter in the wait time for the packet signal length. To address this, a range of a random number settable by the carrier sense unit 90 for carrier sensing is set to be narrower than a range of a random number settable by the vehicle-mounted terminal apparatus 14 for carrier sensing. For example, a range of a random number settable for carrier sensing is defined by 0 to N/2. This corresponds to that a range of the wait time settable by the vehicle-mounted terminal apparatus 14 is shorter than a range of the wait time settable by the portable terminal apparatus 18. The maximum value of the wait time settable by the setting unit 88 is smaller than the maximum value of the wait time settable by the vehicle-mounted terminal apparatus 14 for carrier sensing. Return to FIG. 7. When the setting unit 88 designates that a frame is not defined, the setting unit 88 similarly sets the contention window irrespective of the frame structure.

The carrier sense unit 90 performs carrier sensing for the wait time set in the setting unit 88. The modem unit 74 and the RF unit 72 broadcast a packet signal based on the carrier sensing result of the carrier sense unit 90.

A modification of an exemplary embodiment will be described below. The modification of an exemplary embodiment relates to a portable terminal apparatus carried with a pedestrian similarly as in the embodiment. In the embodiment, the vehicle-mounted terminal apparatus and the portable terminal apparatus broadcast a packet signal in the inter-vehicular transmission period. On the other hand, in the modification, a frame is configured of the road-to-vehicle transmission period, the inter-vehicular transmission period and a pedestrian-to-vehicle transmission period. The vehicle-mounted terminal apparatus broadcasts a packet signal in the inter-vehicular transmission period while the portable terminal apparatus broadcasts a packet signal in the pedestrian-to-vehicle transmission period. That is, the period in which the vehicle-mounted terminal apparatus can broadcast a packet signal and the period in which the portable terminal apparatus can broadcast a packet signal are multiplexed in a time division manner. The communication system 100, the base station apparatus 10, the vehicle-mounted terminal apparatus 14 and the portable terminal apparatus 18 according to the modification are of the same types of FIG. 1, FIG. 2, FIG. 6 and FIG. 7. Differences will be mainly described herein.

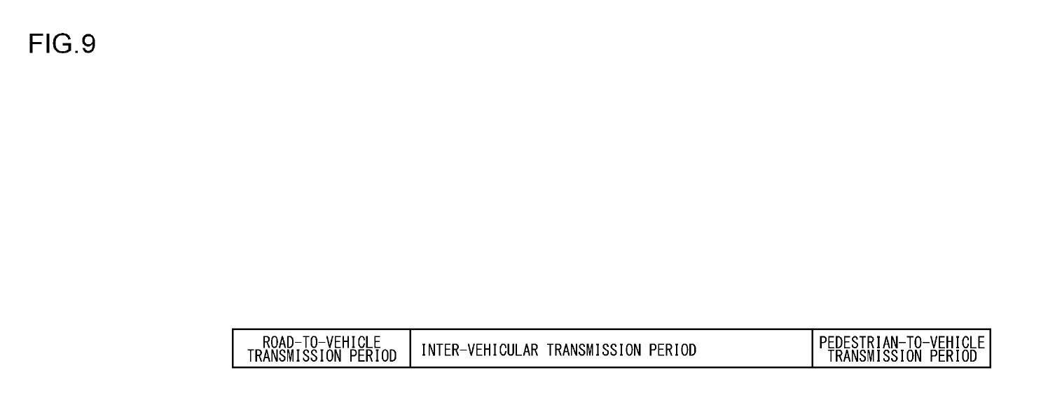

FIG. 9 illustrates a format of a frame according to the modification of the present invention. As illustrated, the frame is configured of the road-to-vehicle transmission period, the inter-vehicular transmission period and the pedestrian-to-vehicle transmission period. As described above, a length of a packet signal broadcasted from the portable terminal apparatus 18 is shorter than a length of a packet signal broadcasted from the vehicle-mounted terminal apparatus 14, and thus a length of the pedestrian-to-vehicle transmission period is defined to be shorter than a length of the inter-vehicular transmission period. On the other hand, the length of the pedestrian-to-vehicle transmission period may be defined to be longer than the length of the pedestrian-to-vehicle transmission period assuming that the number of portable terminal apparatuses 18 capable of broadcasting a packet signal in the pedestrian-to-vehicle transmission period is more than the number of vehicle-mounted terminal apparatuses 14 capable of broadcasting a packet signal in the inter-vehicular transmission period. The length of the pedestrian-to-vehicle transmission period may be defined to be equal to the length of the inter-vehicular transmission period. The information on the frame structure is stored in the packet signal from the base station apparatus 10. The extraction unit 52 in FIG. 6 specifies the inter-vehicular transmission period and the extraction unit 86 in FIG. 7 specifies the pedestrian-to-vehicle transmission period. The carrier sense unit 54 in FIG. 6, and the setting unit 88 and the carrier sense unit 90 in FIG. 7 perform the same processings as before.

Another modification of an exemplary embodiment will be described below. Another modification of an exemplary embodiment relates to a portable terminal apparatus carried with a pedestrian. In another modification, the frame is configured of the road-to-vehicle transmission period, the inter-vehicular transmission period and the pedestrian-to-vehicle transmission period similarly as in the modification. The pedestrian-to-vehicle transmission period in another modification is formed of a plurality of slots. The portable terminal apparatus selects any of the slots, and broadcasts a packet signal in the selected slot. Thus, the portable terminal apparatus does not perform carrier sensing. The communication system 100, the base station apparatus 10, the vehicle-mounted terminal apparatus 14 and the portable terminal apparatus 18 according to another modification are of the same types of FIG. 1, FIG. 2, FIG. 6 and FIG. 7. Differences will be mainly described herein.

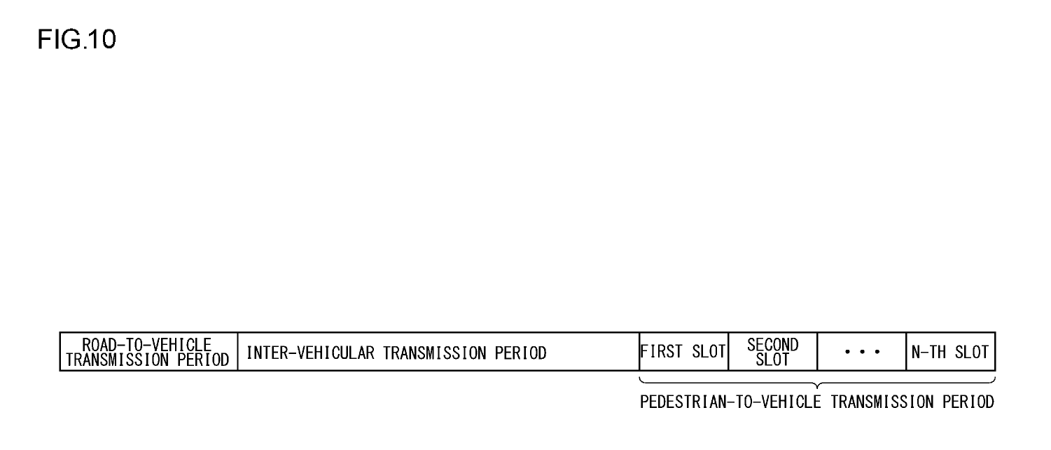

FIG. 10 illustrates a format of a frame according to another modification of an exemplary embodiment. The frame illustrated in FIG. 10 is configured of the road-to-vehicle transmission period, the inter-vehicular transmission period, and the pedestrian-to-vehicle transmission period similarly as in FIG. 9. The pedestrian-to-vehicle transmission period is configured of the first slot to the N-th slot. Information on the frame structure is stored in the packet signal from the base station apparatus 10. The extraction unit 52 of FIG. 6 specifies the inter-vehicular transmission period and the extraction unit 86 of FIG. 7 specifies the pedestrian-to-vehicle transmission period and each slot. The setting unit 88 of FIG. 7 selects one of a plurality of slots. For example, one slot is randomly selected. At this time, the carrier sense unit 90 performs carrier sensing 100 msec before, or one frame before. The carrier sensing result is used in the setting unit 88. The generation unit 82 generates a packet signal to be broadcasted in the slot selected in the setting unit 88. Herein, a length of the packet signal generated in the generation unit 82 is assumed to be fixed. On the other hand, a length of the packet signal generated in the generation unit 62 in FIG. 6 is assumed to be variable.

According to the embodiment of the present invention, carrier sensing is performed in the inter-vehicular transmission period specified by the frame information notified from the base station apparatus, and thus, even when a packet signal is broadcasted from the portable terminal apparatus, an impact on a packet signal broadcasted from the vehicle-mounted terminal apparatus can be reduced. The range of the wait time is narrower than the range of the wait time of the vehicle-mounted terminal apparatus, and thus a packet signal can be preferentially transmitted in a short wait time. Since a packet signal is easily transmitted in a short wait time, the presence position can be immediately notified. The transmission power of the packet signal broadcasted from the portable terminal apparatus is set to be lower than the transmission power of the packet signal broadcasted from the base station apparatus or the vehicle-mounted terminal apparatus, thereby reducing an impact given to the latter. Further, the transmission power is set to be low, and thus consumed power can be reduced. The consumed power is reduced, and thus a drive time can be made longer. The pedestrian-to-vehicle transmission period is separately defined, thereby reducing an impact on the inter-vehicular communication. A packet signal is broadcasted in units of slot in the pedestrian-to-vehicle transmission period, thereby enhancing a transmission efficiency.

The present invention has been described above by way of the embodiment. The embodiment is exemplary, and those skilled in the art may understand that various modifications of combination of the components and the processes are possible and such modifications are also encompassed in the scope of the present invention.

According to the embodiment of the present invention, the maximum value of the wait time settable by the portable terminal apparatus 18 is set to be smaller than the maximum value of the wait time settable by the vehicle-mounted terminal apparatus 14 for carrier sensing. However, it is not limited thereto, and the range of the wait time settable by the setting unit 88 maybe shifted from the range of the wait time settable by the vehicle-mounted terminal apparatus 14 for carrier sensing. By way of example, the contention window of the setting unit 88 is defined in “0” to “15” and the contention window of the vehicle-mounted terminal apparatus 14 is defined in “16” to “63.” According to the modification, the wait times are shifted, thereby reducing a probability of collision of the packet signals.

According to the embodiment of the present invention, the maximum value of the wait time settable by the portable terminal apparatus 18 is set to be smaller than the maximum of the wait time settable by the vehicle-mounted terminal apparatus 14 for carrier sensing. However, it is not limited thereto, and the wait time settable by the setting unit 88 may be fixed and the wait time settable by the vehicle-mounted terminal apparatus 14 for carrier sensing may be variable. By way of example, the setting unit 88 sets SIFS and the like. According to the modification, a packet signal from the portable terminal apparatus 18 can be preferentially broadcasted.

According to the embodiment of the present invention, the vehicle-mounted terminal apparatus 14 and the portable terminal apparatus 18 are independently configured. However, they are not limited thereto, and they may be configured as one terminal apparatus. The terminal apparatus is the vehicle-mounted terminal apparatus 14 when operating in the vehicle-mounted mode and the portable terminal apparatus 18 when operating in the portable mode. The terminal apparatus may be regarded as the vehicle-mounted terminal apparatus 14 or the portable terminal apparatus 18 depending on a situation. According to the modification, one terminal apparatus having the functions of both the apparatuses can be realized.

According to the modification and another modification of an exemplary embodiment, the frame or subframe is configured of the road-to-vehicle transmission period, the inter-vehicular transmission period, and the pedestrian-to-vehicle transmission period. The lengths of the inter-vehicular transmission period and the pedestrian-to-vehicle transmission period are not particularly determined. However, they are not limited thereto, and information on a ratio between the inter-vehicular transmission period and the pedestrian-to-vehicle transmission period may be contained in the message header. With the structure, the lengths of the inter-vehicular transmission period and the pedestrian-to-vehicle transmission period are controlled by a packet signal broadcasted from the base station apparatus 10. The inter-vehicular transmission period: pedestrian-to-vehicle transmission period may be set at one to zero or zero to one. According to the modification, the inter-vehicular transmission period and the pedestrian-to-vehicle transmission period can be flexibly adjusted.

An outline of an aspect of the present invention is as follows. A terminal apparatus according to an aspect of the present invention comprises a receiving unit for receiving a packet signal from a base station apparatus, the packet signal containing information on a frame structure, in a first period in a frame containing at least the first period and a second period, a specification unit for specifying the second period in the frame based on the packet signal received in the receiving unit, a setting unit for setting a wait time in the second period specified in the specification unit, a carrier sense unit for performing carrier sensing for the wait time set in the setting unit, and a broadcasting unit for broadcasting a packet signal based on the carrier sensing result in the carrier sense unit. A range of the wait time settable by the setting unit is narrower than a range of the wait time settable for carrier sensing by other terminal apparatus capable of broadcasting a packet signal in the second period.

According to the aspect, the range of the wait time is narrower than the range of the wait time of other terminal apparatus, and thus a packet signal can be preferentially transmitted in a short wait time.

A maximum value of the wait time settable by the setting unit is smaller than a maximum value of the wait time settable by other terminal apparatus for carrier sensing. In this case, a packet signal from the terminal apparatus can be preferentially broadcasted.

The range of the wait time settable by the setting unit may be shifted from the range of the wait time settable by other terminal apparatus for carrier sensing. In this case, the wait times are shifted, thereby reducing a probability of collision of the packet signals.

The wait time settable by the setting unit may be fixed and the wait time settable by other terminal apparatus for carrier sensing may be variable. In this case, a packet signal from the terminal apparatus can be preferentially broadcasted.

An outline of another aspect of the present invention is as follows. A terminal apparatus comprising: a setting unit configured to set a wait time for broadcasting a packet signal; a carrier sense unit configured to perform carrier sensing for the wait time set in the setting unit; and a broadcasting unit configured to broadcast a packet signal based on a result of the carrier sensing in the carrier sense unit, wherein a range of the wait time settable by the setting unit is narrower than a range of the wait time settable for carrier sensing by other terminal apparatus.

What is claimed is:

1. A terminal apparatus comprising:
a receiving unit configured to receive a packet signal from a base station apparatus, the packet signal containing information on a frame structure in a first period in a frame containing at least the first period and a second period;
a specification unit configured to specify the second period in the frame based on the packet signal received in the receiving unit;
a setting unit configured to set a wait time in the second period specified in the specification unit;
a carrier sense unit configured to perform carrier sensing for the wait time set in the setting unit; and
a broadcasting unit configured to broadcast a packet signal based on a result of the carrier sensing in the carrier sense unit,
wherein a range of the wait time settable by the setting unit is narrower than a range of the wait time settable for carrier sensing by other terminal apparatus capable of broadcasting a packet signal in the second period.

2. The terminal apparatus according to claim 1, wherein a maximum value of the wait time settable by the setting unit is smaller than a maximum value of the wait time settable by other terminal apparatus for carrier sensing.

3. The terminal apparatus according to claim 1, wherein a range of the wait time settable by the setting unit is shifted from a range of the wait time settable by other terminal apparatus for carrier sensing.

4. The terminal apparatus according to claim 1, wherein the wait time settable by the setting unit has a fixed value and the wait time settable by other terminal apparatus for carrier sensing has a variable value.

5. A terminal apparatus comprising:
a setting unit configured to set a wait time for broadcasting a packet signal;
a carrier sense unit configured to perform carrier sensing for the wait time set in the setting unit; and
a broadcasting unit configured to broadcast a packet signal based on a result of the carrier sensing in the carrier sense unit,
wherein a range of the wait time settable by the setting unit is narrower than a range of the wait time settable for carrier sensing by other terminal apparatus.
